(19) United States
(12) Patent Application Publication
(10) Pub. No.: US 2004/0009837 A1
(43) Pub. Date: Jan. 15, 2004

(54) Automatic locked-center idler

(76) Inventors: Alexander Serkh, Troy, MI (US); Andrzej Dec, Rochester Hills, MI (US)

Correspondence Address: Steven G. Austin, The Gates Corporation, Mail Stop 31-4-1-A3, 900 S. Broadway, Denver, CO, 80209, US

(21) Appl. No.: 10/617,628

(22) Filed: Jul. 10, 2003

Related U.S. Application Data
(60) Provisional application No. 60/395,773, filed on Jul. 11, 2002.

(51) Int. Cl. F16H 7/12; F16H 55/36

(52) U.S. Cl. 474/135; 474/133; 474/199

(57) ABSTRACT

The invention is an improved locked-center idler of the type having a pulley supported by a bearing. The bearing is mounted upon a tension adjusting member. It is improved by the tension adjusting member being in communication with a dual function fastener.

### BACKGROUND OF THE INVENTION

1. Field of the Invention

This invention relates generally to an automatic locked-center idler for tensioning a power transmission belt of a belt drive system. Particularly, this invention relates to an automatic locked-center idler that provides an initial tension setting for a belt drive system. Specifically, this invention relates to such an automatic locked-center idler for a power transmission belt drive system to drive accessories of an internal combustion engine use.

2. Description of the Prior Art

It is known to use a locked-center idler in conjunction with an accessory belt drive system, for an internal combustion engine, that provides an initial belt tension to remove slack from the belt. For one version of locked-center idler, the installation entails first fastening the idler loosely in place. The installer then forces the idler, including its tensioning member supporting the pulley and the pulley, against the power transmission belt to create substantial tension upon the belt. While holding the idler in this condition, the installer must then tighten the fastener of the idler to fix it in place. This installation procedure is fairly strenuous, particularly when performed repeatedly throughout a shift. Further, it is prone to error. The idler can readily be tightened with insufficient tension or no tension placed upon the belt.

Another version of locked-center idler incorporates a pre-loaded spring. Installation of this version entails fastening the idler firmly in place. Then, activating the pre-loaded spring moves the pulley into tensioning position against the belt. This installation procedure is less strenuous and less prone to error. There is less opportunity for the idler to provide some but insufficient belt tension. However, this procedure still allows an installation where activation of the pre-loaded spring is forgotten. Thus, no initial tension is placed upon the belt. Further, this version of locked-center idler is more complicated in design and construction with the attendant increase in expense to build.

Prior art locked-center idlers have been limited to being either difficult and error prone to install, or more complicated of design and still relatively error prone to install. Accordingly, there is a continuing need for a locked-center idler that is at once less strenuous to install, less prone to being incorrectly installed, but remains simple in design and construction.

### SUMMARY OF THE INVENTION

An automatic locked-center idler is disclosed herein. The invention is an improved locked-center idler of the type having a pulley supported by a bearing. The bearing is mounted upon a tension adjusting member. It is improved by the tension adjusting member being in communication with a dual function fastener.

### BRIEF DESCRIPTION OF THE DRAWINGS

The accompanying drawings, which are incorporated in and form part of the specification in which like numerals designate like parts, illustrate preferred embodiments of the present invention and together with the description, serve to explain the principles of the invention. In the drawings:

FIG. 1 is a plan view of a preferred embodiment of an automatic locked-center idler;

FIG. 2 is a section of the preferred embodiment of an automatic locked-center idler depicted in FIG. 2 taken along line 2-2;

FIG. 3 is a plan view of a preferred embodiment of an automatic locked-center idler;

FIG. 4 is a section of the preferred embodiment of an automatic locked-center idler depicted in FIG. 3 taken along line 4-4;

FIG. 5 is a plan view of a preferred embodiment of an automatic locked-center idler; and,

FIG. 6 is a section of the preferred embodiment of an automatic locked-center idler depicted in FIG. 5 taken along line 6-6;

### DETAILED DESCRIPTION OF THE PREFERRED EMBODIMENTS

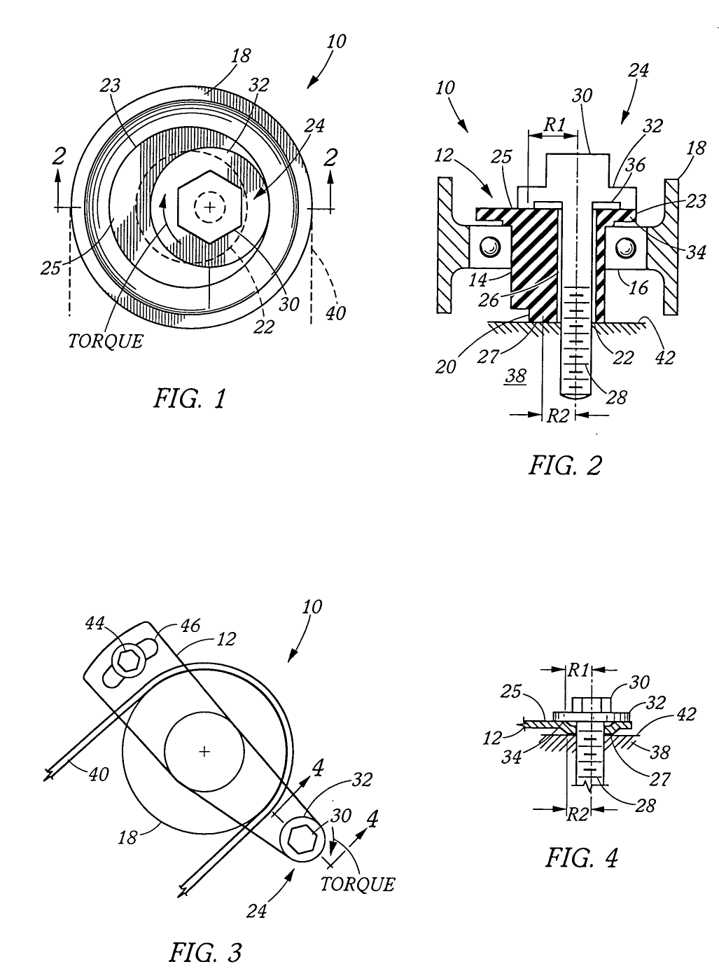

FIGS. 1 and 2 depict a preferred embodiment of automatic locked-center idler 10. It includes tensioning member 12 having main cylindrical portion 14 which supports bearing 16. The bearing 16 depicted is of the most commonly used type for such applications, a ball bearing. However, other bearing types may be appropriate. Pulley 18 is mounted upon bearing 16 in common fashion. Tensioning member 12 further includes secondary cylindrical portion 20 having eccentric bore 22 running axially there through and through main cylindrical portion 14. Extending radially above main cylindrical portion is ledge 23 having reaction friction surface 25. Under secondary cylindrical portion 20 is resistance friction surface 27.

Locked-center idler 10 also includes dual function fastener 24. Dual function fastener 24 has shaft 26, upon which are threads 28. Dual function fastener also includes head 30 which is depicted as hexagonal. However, any appropriate head shape is contemplated. Extending radially from shaft 28 and adjacent to head 30 is flange 32. Flange 32 further includes reaction mating surface 34 and annular recess 36. The average radius of the contact of reaction mating surface 34 upon reaction friction surface 25 is defined as reaction radius R1. The average radius of the contact of resistance friction surface 27 upon mount 38 is defined as R2.

In practice, automatic locked-center idler 10 is assembled as depicted in FIGS. 1 and 2. Automatic locked-center idler 10 is placed upon mount 38. Mount 38 can be the cylinder block of an internal combustion engine or a separate structure that is immobile in reference to the cylinder block. Power transmission belt 40 is trained about pulley 18. Dual function fastener 24 is threaded into mating threads (not depicted) of mount 38. Dual function fastener 24 is tightened. As dual function fastener 24 is tightened: 1) tensioning member 12 is clamped between mount 38 and reaction mating surface 34; and, 2) flange 32 and reaction mating surface 34 rotate.

It is fundamental that the torque generated by the reaction friction between reaction friction surface 25 and reaction mating surface 34, the reaction torque, is greater than the torque generated by the resistance friction between resistance friction surface 27 and mounting surface 42 of mount 38, the resistance torque.

These relative torques can be accomplished in a number of ways. One group of ways is to control the relative coefficients of friction of the reaction friction and the resistance friction. By way of example, this can be done by selection of dissimilar materials. For example, if dual function fastener 24 and tension adjusting member 12 are common steel while mount 38 is aluminum, then the static coefficient of friction giving rise to the reaction friction will be relatively large, approximately 0.7; the static coefficient of friction giving rise to the resistance friction will be relatively small, approximately 0.45. However, the dynamic coefficients of friction are much closer together. Further, there can be many overriding factors that may limit which materials are available for this application. Accordingly, selection of materials may not always be available as an effective approach. Another example of controlling relative coefficients of friction is interjecting a lubricant to reduce resistance friction. Further, various coatings can be applied to surfaces 25, 27, 34, or 42 to modify relative coefficients of friction. Additionally, surfaces 25, 27, 34, or 42 can be textured to modify relative coefficients of friction.

Another approach to controlling relative torques is to control the lever arms acted upon by the reaction friction and the resistance friction. As is apparent, the axial force delivered to all surfaces 25, 27, 34, and 42 are the same. Further, torque is the resultant of force acting through a lever arm. If the reaction coefficient of friction equals the resistance coefficient of friction, and radius R1 equals radius R2, then the reaction torque equals the resistance torque. As torque is a linear function relative to the length of the lever arm, the ratio of the two radii R1 and R2 determines the relative levels of torque, prior to slippage of any of surfaces 25, 27, 34, or 42. Accordingly, making radius R1 larger than radius R2, as depicted, results in reaction torque being larger than resistance torque. It can thus be expected that resistance friction surface 27 will slide against mounting surface 42 first, causing resistance torque to drop suddenly as the associated coefficient of friction drops suddenly in going from static to dynamic.

In the embodiment depicted in FIGS. 1 and 2, with radius R1 larger than radius R2, as dual function fastener 24 is tightened, tensioning member 12 is rotated. Because of the placement of eccentric bore 22, tightening member 12 and pulley 18 move toward belt 40. This leads to a longer path for belt 40 and tightening of belt 40. Once belt 40 reaches a certain degree of tension, the reaction torque minus the resistance torque will no longer be enough to continue to rotate tightening member 12 and slippage will occur between reaction friction surface 25 and reaction mating surface 34. Sometime after this point, dual function fastener is no longer tightened. Belt 40 will have been tightened to the desire setting. Also, automatic locked-center idler will have been affixed to mount 38. The ratio of radius R1 and radius R2 can be chosen to either produce a tension on belt 40 merely enough to remove the slack from the belt or any other operating amount.

Optional annular recess 36 is depicted in this embodiment. Annular recess 36 allows greater control over the point at which tensioning member 12 no longer rotates in response to belt tension. It both makes the mating area of reaction friction surface 25 and reaction mating surface 34 more consistent during tightening of dual function fastener 24 and allows give in flange 32 so that the point at which automatic locked-center idler is adequately fixed to mount 38 is less critical.

The embodiment of FIGS. 3 and 4 utilizes the same principle of rotating tensioning member 12 by the difference of reaction torque to resistance torque. However, tensioning member 12 is reformed in the shape of the plate depicted in FIGS. 3 and 4. Tensioning member 12 also includes all necessary remaining structure to support bearing 16 and pulley 18. As with the prior embodiment, reaction torque is the result of torque generated by the reaction friction between reaction friction surface 25 and reaction mating surface 34 multiplied by radius R1 when dual function fastener 24 is placed into dual function fastener receiving bore 52 and tightened. Likewise, resistance torque is the result of torque generated by the resistance friction between resistance friction surface 27 and mounting surface 42 of mount 38 multiplied by radius R2.

This configuration cannot be expected to produce as much tension on belt 40 is can the prior embodiment. The amount of pressure idler 10 can place upon belt 40 is the torque placed upon tension member 12 divided by the length of the lever arm defined by the distance from the center of dual function fastener to the center of pulley 18. As can be seen, the lever arm of the prior embodiment is much shorter than the lever arm of the current embodiment. However, the construction of this embodiment has the advantage that tensioning member 12 is of a plainer design and applicable to certain engine and power transmission drive geometries.

It is contemplated that for those belt drive power transmission systems that operate under high tensions, securing bolt 44 operating within securing slot 46 may be necessary to stabilize the tension supplied by automatic locked-center idler 10.

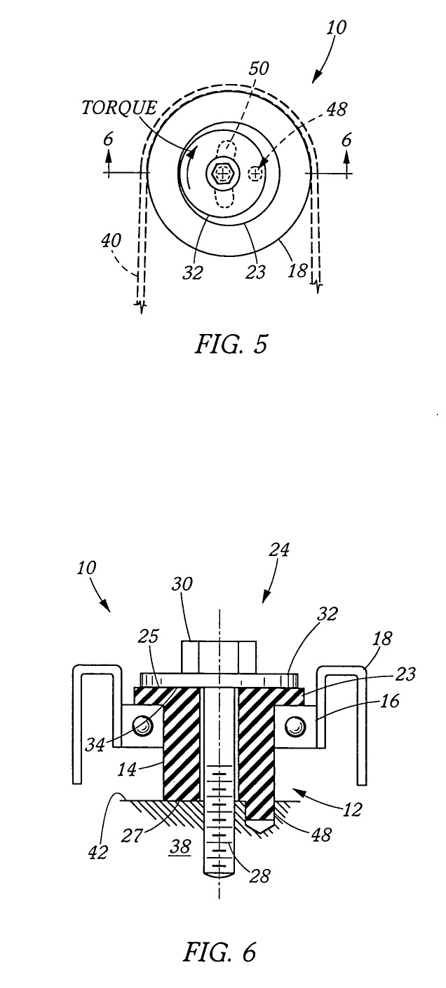

The embodiment of FIGS. 5 and 6 operates similarly to the embodiment of FIGS. 1 and 2 and utilizes the same principle of rotating tensioning member 12 by the difference of reaction torque to resistance torque. A substantial difference lies in the point about which tensioning member 12 pivots. In the first embodiment, tensioning member 12 pivots about dual function fastener 24. In the current embodiment, tensioning member 12 pivots about pivot 48 extending axially from resistance friction surface 14. To accommodate the different pivot point, eccentric bore 22 is replaced by tensioning slot 50.

As with the prior embodiments, reaction torque is the result of torque generated by the reaction friction between reaction friction surface 25 and reaction mating surface 34. Likewise, resistance torque is the result of torque generated by the resistance friction between resistance friction surface 27 and mounting surface 42 of mount 38.

In sum, the preferred embodiments described herein and depicted in the Figures allow an automatic locked-center idler of simple design and construction that is installable without being unduely strenuous or error prone.

The foregoing description and illustrative embodiments of the present invention have been shown on the drawings and described in detail in varying modifications and alternative embodiments. It should be understood, however, that the foregoing description of the invention is exemplary only, and that the scope of the invention is to be limited only to the claims as interpreted in view of the prior art. Moreover, the invention illustratively disclosed herein suitably may be practiced in the absence of any element that is not specifically disclosed herein.

What is claimed is:

1. An improved locked-center idler of the type having a pulley supported by a bearing, said bearing mounted upon a tension adjusting member, the improvement comprising:
said tension adjusting member being in communication with a dual function fastener.

2. The improvement of claim 1 wherein said tension adjusting member comprises a cylindrical portion adapted to cooperate with an inner portion of a bearing and an eccentric bore axially there through.

3. The improvement of claim 1 wherein said tension adjusting member comprises a reaction friction surface and a resistance friction surface.

4. The improvement of claim 3 wherein said reaction friction surface cooperates with a reaction mating surface of said dual function fastener to produce a reaction torque upon said tension adjusting member greater than a resistance torque produced by a cooperation of said resistance friction surface with a mounting surface.

5. The improvement of claim 1 wherein said tension adjusting member comprises an arm with a pulley mounting portion and a dual function fastener receiving bore.

6. The improvement of claim 1 wherein said tension adjusting member comprises a cylindrical portion adapted to coorperate with an inner portion of a bearing, a pivot extending axially and offset from the center of said cylindrical portion, a curved slot opening through the length of said cylindrical portion and having a mean curvature with an arc that defines a radius about said pivot.

7. A locked-center idler comprising:
a pulley supported by a bearing
said bearing mounted upon a tension adjusting member, and
said tension adjusting member in communication with a dual function fastener.

8. The locked-center idler of claim 7 wherein said tension adjusting member comprises a cylindrical portion adapted to cooperate with an inner portion of a bearing and an eccentric bore axially there through.

9. The locked-center idler of claim 7 wherein said tension adjusting member comprises a reaction friction surface and a resistance friction surface.

10. The locked-center idler of claim 9 wherein said reaction friction surface cooperates with an reaction mating surface of said dual function fastener to produce a reaction torque upon said tension adjusting member greater than a resistance torque produced by a cooperation of said resistance surface with a mounting surface.

11. The locked-center idler of claim 7 wherein said tension adjusting member comprises an arm with a pulley mounting portion and a dual function fastener receiving bore.

12. The locked-center idler of claim 7 wherein said tension adjusting member comprises a cylindrical portion adapted to coorperate with an inner portion of a bearing, a pivot extending axially and offset from the center of said cylindrical portion, a curved slot opening through the length of said cylindrical portion and having a mean curvature with an arc that defines a radius about said pivot.

13. A method of applying tension to a belt drive power transmission system comprising the steps of:
providing a pulley assembly,
mounting said pulley assembly upon a tension adjusting member,
attaching said tension adjusting member upon a mount that is substantially immobile in relation to an engine cylinder block with a dual function fastener,
training a power transmission belt about said pulley assembly,
applying tension to said power transmission belt by applying a tightening torque to said dual function fastener, and
fixing the position of said tension adjusting member by applying said tightening torque to said dual function fastener.
